(19) United States
(12) Patent Application Publication
(10) Pub. No.: US 2008/0147728 A1
(43) Pub. Date: Jun. 19, 2008

(54) EXPOSURE-BASED SCHEDULING

(76) Inventor: Tal Reichert, Somerville, MA (US)

Correspondence Address: FISH & RICHARDSON PC, P.O. BOX 1022, MINNEAPOLIS, MN, 55440-1022, US

(21) Appl. No.: 11/611,481

(22) Filed: Dec. 15, 2006

(51) Int. Cl. G06F 17/30

(52) U.S. Cl. 707/104.1

(57) ABSTRACT

A method for determining a schedule for presenting audiovisual items is disclosed. The method includes providing a plurality of audiovisual items, each of the plurality of audiovisual items associated with a corresponding priority data, assigning to each of the plurality of audiovisual items a corresponding exposure level data representative of the portico of time the corresponding audiovisual item is to be presented during a particular time interval, identifying one or more audiovisual items from the plurality of audiovisual items that are to be included in a playlist of audiovisual items based, at least in part, on the corresponding priority data of the plurality of audiovisual terns, and determining a presentation schedule for the identified one or more audiovisual items based, at least in part, on the corresponding exposure level data.

### TECHNICAL FIELD

This invention relates to scheduling of audiovisual items, and more particularly to exposure-based scheduling of audiovisual items.

### BACKGROUND

Generally, in digital signage apparatus, such as Point-of-Sale (POS) systems that are used to display advertisements and/or other audiovisual items to consumers, the corresponding display device is divided into various windows (or sections) such as rectangular-shaped windows, thus defining the layout of the screen presented on the display device. These windows formed on the screen may be layered such that some display windows are completely visible, other display windows are partially obscured by overlapping windows that partly cover them, and yet other windows are completely obscured.

Each of the windows or sections formed on the display device is generally associated with a playlist. A playlist is a list of items to be displayed, with each item typically having of pre-defined length (in terms of display time). Each item includes content elements such as text (static excerpts or a running feed of text such as an RSS feed), images, movies, captured images from live sources, streaming videos, audio files to be played, web pages and/or a combination of any of the aforementioned content elements.

A playlist generally displays its associated items cyclically, and thus the associated items are displayed in a pre-determined order one after the other with each item being displayed for a period of time corresponding to its length. Once displaying the items of a particular playlist is completed, the playlist may be rewound and displayed from the beginning in the same order. Extraneous factors, such as changing marketing conditions, do not generally affect the order of the playlist the display duration allotted to a particular item of the playlist, and/or the frequency at which the item is presented.

### SUMMARY

In one aspect, a method for determining a schedule for presenting audiovisual stems is disclosed. The method includes providing a plurality of audiovisual items, each of the plurality of audiovisual items associated with a corresponding priority data, assigning to each of the plurality of audiovisual items a corresponding exposure level data representative of the portion of time the corresponding audiovisual item is to be presented during a particular time interval, identifying one or more audiovisual items from the plurality of audiovisual items that are to be included in a playlist of audiovisual items based, at least in part, on the corresponding priority data of the plurality of audiovisual items, and determining a presentation schedule for the identified one or more audiovisual items based, at least in part, on the corresponding exposure level data.

Embodiments may include one or more of the following.

Each of the plurality of audiovisual items may be further associated with a corresponding presentation frequency data representative of the number of times to present the corresponding audiovisual item, and a corresponding duration length data for the corresponding audiovisual item. Assigning to each of the plurality of audiovisual items the corresponding exposure level data may include determining the corresponding exposure level data based on the corresponding presentation frequency data and the corresponding duration length data.

Identifying one or more audiovisual items may include adjusting the exposure level data of at least some of the identified one or more audiovisual items based on the sum of the respective exposure level data of the one or more audiovisual items. Adjusting the exposure level data may include, based on the sum of the respective exposure level data of the identified one or more audiovisual items exceeding a value corresponding to 100%, identifying at least one group of audiovisual items having the same priority level data, and adjusting the exposure level data associated with the audiovisual items in the identified at least one group such that the sum of the respective exposure level data of the identified one or more audiovisual items is equal to a value corresponding to 100%. Adjusting the exposure level data associated with the audiovisual items in the identified at least one group may include multiplying the exposure level data associated with each of the audiovisual items in the at least one group with a corresponding weighing factor.

Determining the presentation schedule may include computing for each of the identified one or more audiovisual items included in the playlist, using the exposure level data, a corresponding time balance value at a corresponding particular time instance, the corresponding time balance value representative of the presentation time the corresponding audiovisual item is entitled to at the corresponding particular time instance, and selecting one audiovisual item from the identified one or more audiovisual items based on the computed time balance value for each of the identified one or more audiovisual items. The selected one audiovisual item may have the highest time balance value.

Computing for each of the identified one or more audiovisual items the corresponding time balance value may include computing the difference between the product of the exposure level data for the corresponding audiovisual item and the total time elapsed at the corresponding particular time instance, and the time the corresponding audiovisual item has already presented at the particular time instance. Computing the corresponding time balance value may further include dividing the computed difference by a duration length data associated with the corresponding audiovisual item.

For each of the identified one or more audiovisual items, the corresponding particular time instance may include, for example, a begin time instance at which the corresponding audiovisual item would begin presenting, an end time instance at which the corresponding audiovisual item would end presenting, and/or a half-way point of the corresponding audiovisual item.

Selecting one audiovisual item from the identified one or more audiovisual items may include applying scheduling rules. Applying scheduling rules may include determining whether a selected candidate audiovisual item violates any of the scheduling rules.

Determining the presentation schedule may include determining an optimal presentation order for the identified one or more audiovisual items based on corresponding time balance values computed for each of the ordered one or more audiovisual items using the exposure level data, the time balance values representative of the presentation time the corresponding audiovisual items are entitled to at a particular time instance.

Determining the optimal presentation order may include computing the difference between the product of the exposure level data for the corresponding audiovisual item and the total time elapsed at the particular time instance, and the time the corresponding audiovisual item has already presented at the particular time instance. Computing the corresponding time balance value may further include dividing the computed difference by a duration length data associated with the corresponding audiovisual item.

Determining the optimal presentation order may include minimizing the area under a curve of a time-based function of for example, a sum of squares of the time balance values for the corresponding identified one or more audiovisual items, a weighted average of the sum of the squares of the time balance values corresponding to the identified one or more audiovisual items, a sum of the absolute values of the time balances of the corresponding one or more identified items, a weighted average based on the exposure level data of the sum of absolute value of the time balance corresponding to the identified one or more audiovisual items, a standard deviation of the identified one or more audiovisual items, and/or a weighted average based on the exposure level data of the standard deviation of the identified one or more audiovisual items. The area under the curve maybe computed using, for example, an analytic integration procedure, and/or a numerical approximation procedure.

Determining the optimal presentation order for the identified one or more audiovisual items may include generating a plurality of candidate presentation orders for the identified one or more audiovisual items, and applying scheduling rules to the plurality of candidate presentation orders. Applying scheduling rules to the plurality of candidate display orders may include determining whether any of the plurality of candidate presentation orders violates any of the scheduling rules.

The method may further include changing for at least one of the plurality of audiovisual items, at a specified time, for example, the corresponding priority data, the corresponding presentation frequency data, and/or the corresponding duration length data. Changing may include modifying at least one of the corresponding priority data, the corresponding presentation frequency data, and the corresponding duration length data based on information sent from a marketing intelligence automated system, the information representative of automatically generated marketing actions.

Providing a plurality of audiovisual items may include receiving data from a user, the data including, for example, data identifying the plurality of audiovisual items, priority data associated with one or more of the plurality of audiovisual items, presentation frequency data associated with another one or snore of the plurality of the audiovisual items, and/or duration length data for a further one or more of the plurality of the audiovisual items.

In another aspect, disclosed is a computer program product residing on a computer readable storage medium for determining a schedule for presenting audiovisual items comprising instructions that when executed on a processor-based device cause the processor-based device in provide a plurality of audiovisual items, each of the plurality of audiovisual items associated with a corresponding priority data, assign to each of the plurality of audiovisual items a corresponding exposure level data representative of the portion of time the corresponding audiovisual item is to be presented during a particular time interval, identify one or more audiovisual items from the plurality of audiovisual items that are to be included in a playlist of audiovisual items based, at least in part, on the corresponding priority data of the plurality of audiovisual items, and determine a presentation schedule for the identified one or more audiovisual items based, at least in part, on the corresponding exposure level data.

in yet another aspect, disclosed is a system that includes a display device configured to present one or more playlists of audiovisual items, and a processor electrically connected to a memory module. The memory module stores instructions that when executed on the processor cause the processor to, for each of at least some of the one or more playlists, provide a plurality of audiovisual items, each of the plurality of audiovisual items associated with a corresponding priority data, assign to each of the plurality of audiovisual items a corresponding exposure level data representative of the portion of time the corresponding audiovisual item is to be presented during a particular time interval, identify one or more audiovisual items from the plurality of audiovisual items that are to be included in the corresponding playlist of audiovisual items based, at least in part, on the priority data corresponding to the plurality of audiovisual items, and determine a presentation schedule for the identified one or more audiovisual items based, at least in part, on the corresponding exposure level data.

While the methods, products and systems disclosed herein describe the scheduling of audiovisual items, these methods, systems and products, may also be applied and/or used to schedule other types of items, events, etc. For example, the disclosed method maybe applied to schedule electronic transmission (e.g., e-mail communications), promotions and/or playlists.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 is a schematic diagram of an exemplary embodiment of a Point-of-Sale (POS) system.

FIG. 2 is a schematic diagram of an exemplary generic embodiment of the input/output devices of POS system of FIG 1.

FIG. 3 is a diagram of an exemplary embodiment of a data structure to maintain the content data for an audiovisual item and the associated attribute information for the audiovisual item.

FIG. 4 is a flowchart of an exemplary embodiment of a procedure for identifying one or more audiovisual items to be included in a playlist.

FIG. 5 is a flowchart of an exemplary embodiment of a scheduling procedure based on greedy scheduling strategies.

FIG. 6 is a flowchart of an exemplary embodiment of a scheduling procedure based on optimization scheduling strategies.

FIGS. 7A and 78 are graphs showing time-balance behaviors resulting from two different scheduling orders of audiovisual items using an optimization scheduling strategy.

FIG. 7C is a graph comparing the sum of squares curves produced in FIGS. 7A and 7B.

FIG. 8 is a schematic diagram of an exemplary embodiment of a system for automatically controlling marketing actions.

Like reference symbols in the various drawings indicate like elements.

### DETAILED DESCRIPTION

### Point-of-Sale Devices

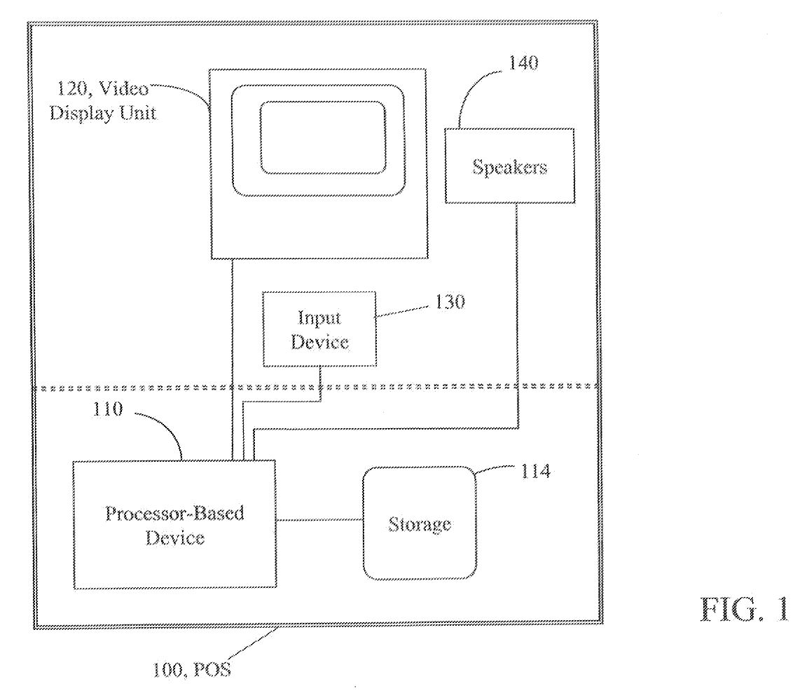

FIG. 1 is a schematic diagram of an exemplary embodiment of a signage device 100, also referred to a Point-of-Sale (“POS”) device, that is configured to present audiovisual items, arranged in playlists, in which the audiovisual items are scheduled based on such factors as the duration length and/or the priority level associated with the audiovisual items. The POS system 100, as well as similar POS systems, may be situated at a particular location within a retail outlet. Accordingly, the audiovisual items to be presented on the POS 100 device may depend on the location within the outlet in which the POS system 100 is located.

As described herein, audiovisual items can include marketing advertisements, as well as other types of promotional, educational, and entertainment items. Such audiovisual items can include text elements (e.g., a static excerpt of a running feed of text such as an RSS feed), images, movies, captured images from live sources, streaming videos, audio files to be played, web pages, and/or a combination of any of the aforementioned elements. Other types of content elements may also be included. In some embodiments, and as will be described herein, the POS system 100 is also configured to collect information regarding the consumers' interests and actions with respect to the products/services presented on the POS systems 100 in FIG. 1.

As shown, the POS system 100, includes a processor-based device 110 such as a personal computer, a personal digital assistant, a specialized computing device or a reading machine, etc., that typically includes a central processor unit (CPU). In addition to the CPU, the system includes main memory, cache memory and bus interface circuits (not shown). The processor-based device 110 includes a mass storage element 114, such as a hard drive associated with personal computer systems.

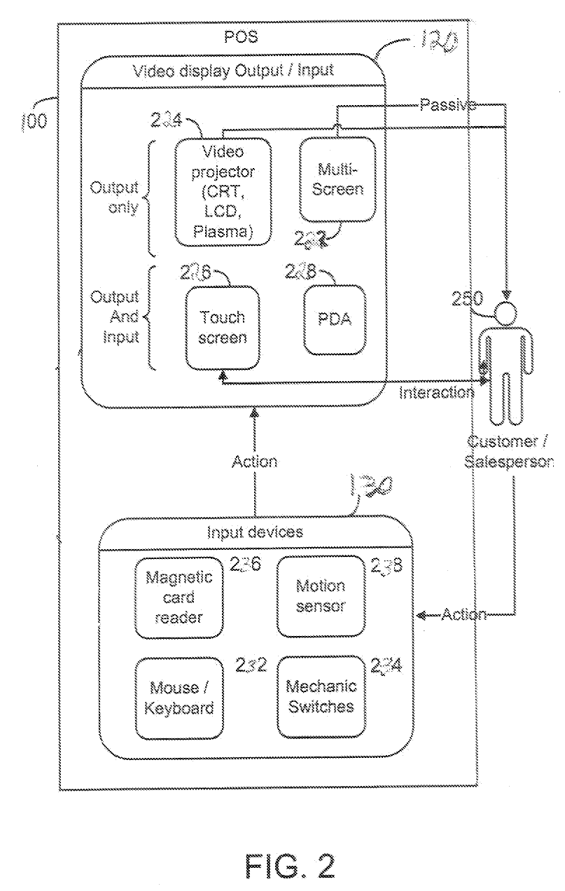

The POS system 100 also includes a video display output/input unit 120 on which the audiovisual items that are arranged in the various playlists are presented. With reference to FIG. 2, showing a schematic diagram of an exemplary generic embodiment of the input/output devices of the POS system 100, the video display unit 120 can include one or more of display devices such as a multi-screen device 222, and/or a video projector 224. Examples of suitable video projector devices that the video display unit 120 may use include cathode-ray-tube based devices, liquid crystal display type devices, and/or plasma type display device. Other types of devices may be used.

Alternatively and/or additionally, the video display unit 120 can include devices whose display surface is configured to receive input from a user 250 (such as a customer or a salesperson) interacting with the POS system 100. Thus, in some embodiments the video display unit 120 may include a touch screen device 226 having a touch sensitive surface to enable users to enter data and/or make selections by directly touching areas of the screen as directed by graphical prompts appearing on the screen. In some embodiments the video display unit 120 may include a personal digital assistance (PDA) device 228. For such embodiments a user may interact with the POS system 100 using a stylus pen to make selections and/or enter data by pressing specific areas of the screen of the PDA device 228.

Optionally, the POS system 100 may include peripheral input device unit 130 to enable a user to interact with the processor-based device 110 of the POS system 100, and enter input to control, for example, the presentation of the playlists, or to provide useful information that may be further processed and used, for example, to invoke marketing actions. With reference again to FIG. 2, the input device unit 130 includes one or more of input devices to enable the user 250 to enter data and make selections in a variety of ways. Thus, for example, the input device unit 130 may include a mouse/keyboard device 232, and/or mechanical switches unit 234. The input device unit may also employ information gathering devices that do not require the user to directly respond to prompts or content displayed on the video display unit 120. For example, the input device 130 may include a magnetic card reader 236. A user wishing to view content on the POS system 100 would be required to swipe a magnetic card (e.g., a credit card). Although the POS system would not necessarily request the user to otherwise enter input to control the displayed content, the content on the POS system 100 may nevertheless be influence by the information read from the swiped magnetic card. For example, information on the magnetic card may identify a user, and thus cause a pre-formed playlist to begin its presentation. Additionally or alternatively, the information may indicate demographical information associated with the user (e.g., gender, age, etc.), and thus enable the remote server to form a new playlist that includes audiovisual items that may be of interest to that particular user.

The input device unit 130 may also include a motion sensor 238. Such a motion sensor is configured to detect the presence of a user in the vicinity of the POS system 100, and thereby cause the POS system to begin displaying content on the video display unit 126.

The input device unit 130 may include other types of data entry and/or data collection devices.

The POS system 100 also includes speakers 140 driven by a sound card (not shown). The processor-based device 110 includes an operating system, e.g., Windows XP® Microsoft Corporation operating system. Alternatively, other operating systems could be used.

As will become apparent below, the processor-based device 110 is configured, through execution of computer program applications on the processor-based device 100, to schedule a plurality of audiovisual items in a particular order according to attributes associated with the audiovisual items such as the items' priority level, duration length, and desired frequency of presentation. The processing-based device is configured to determine an order based on one of several scheduling scheme, including “greedy” schemes and/or optimization schemes, that determine the presentation order according to a computed “time-balance” measure associated with each of the audiovisual items that are to be scheduled. The time-balance value which represents a running balance (analogous to banking account balances) indicative of a degree of presentation entitlement for an associated audiovisual item. The audiovisual items so scheduled are included in one or more playlists that are presented on the video display unit 120 and speakers 140. In some embodiments, every time an audiovisual item is displayed, its information is added to a database maintaining records of shown information. This information may then be processed and reported.

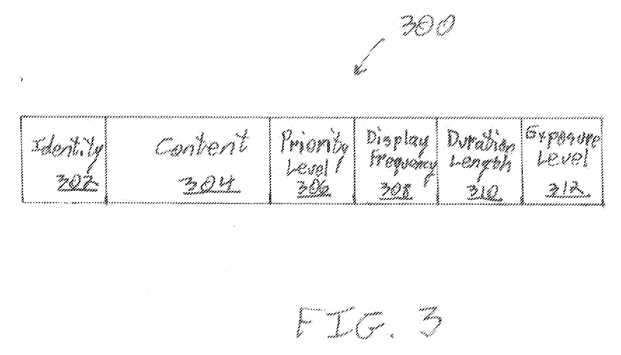

The storage device 114 may include a computer program product that when executed on the processor-based device 110 results in performance of the scheduling operation described herein with reference to FIGS. 3-7, and in presenting the one or playlists of audiovisual items on the video display unit 120 and the speakers 140.

The content to be displayed on the playlists (i.e., the audiovisual items) presented on the video display unit 120 and speakers 140 of the POS system 100 is stored on a storage module 114 of the POS system 100. Such a storage module may include volatile and non-volatile memory, CD-ROM, portable storage media such as CD and DVD placed in corresponding reading devices, flash memory devices, and other types of storage devices. Alternatively, in some embodiments the content corresponding to the audiovisual items may be stored on a remote server that distributes content to one or more POS systems. The content then delivered to the POS system 100 may be varied over time, and may be based on automated marketing decisions made, for example, by a marketing intelligence system such as the one described in U.S. patent application Ser. No. 11/314,711, entitled “Systems and Methods for Automatic Control of Marketing Actions,” the content of which is hereby incorporated by reference in its entirety.

As noted, in addition to presenting content to consumers, the POS system 100 is also configured to collect input from the consumers. The collected input is subsequently processed to generate useful information that can be compiled and presented to an some user for reporting purposes, and/or may be used to determine marketing actions in real-time or near real-time, by adjusting marketing attributes corresponding to one or more products and/or services, as more particularly explained in U.S. patent application Ser. No. 11/314,713. Such marketing attributes include price, package deal offerings, in-store advertisement, out-of-store advertisement, and inventory level corresponding to the various products and services in respect to which the POS system 100 presents content.

### Audiovisual Items

Selection of which audiovisual items are assigned for a particular playlist, and the subsequent determination of the schedule for those selected audiovisual items is determined, at least in part, in accordance with several attributes and/or measures associated with each audiovisual item. Each audiovisual item can be formed as a data structure (e.g., a record, a file) that also includes the attributes as fields of the record. Alternatively, the audiovisual content and the attribute information can subsist as separate records that are linked to each other using, for example, computer memory pointers. FIG. 3 is a diagram of an exemplary embodiment of a data structure 300 to maintain the content data for an audiovisual item and the associated attribute information for the audiovisual item. As shown, data structure 300 includes the identity field 302 that identifies the audiovisual item. The identity field can identify the audiovisual as a semantically meaningful name (e.g., “Product A advertisement”) and/or it may identify the content using an identification number or code.

The content field 304 includes the actual content corresponding to the audiovisual item associated with the particular record. The content stored in the content field 304 may be provide in one of different types of content formats, such as MPEG-4, Wave Media, and/or other types of digital video formats in circumstances where the audiovisual item is a video clip, such as an advertisement. In other circumstances, for example, where the audiovisual item is constituted as a text item combined with an audio segment, the content data in content field 304 may include MP3 data corresponding to the audio portion of the item, and text data, or HTML data, corresponding to the textual content of the item. Because the storage requirements for holding the content data may be significant, the size of this field may be allocated dynamically when the audiovisual item is formed. Alternatively, a standard size storage space for content field 304, corresponding to the largest storage space that may be required for any given audiovisual item, may be allocated thus causing all data records having a structure such as data structure 300, to be of uniform size. As noted above, in some embodiments, the actual data content may be organized in a record or file that is separate from the rest of the attribute information associated with the audiovisual item. Such a separate record for the content maybe provided either as digital data, or as analog data.

As further shown, attribute data associated with the audiovisual item is maintained in a priority level field 306, a display frequency field 308, and a duration length field 310. More specifically, the priority level field 306 maintains data regarding a priority assigned to the associated audiovisual item. That priority level represent the priority of the audiovisual item relative to other visual items, and this data can thus be used to determine, among other things, which audiovisual items would be selected to be included in a particular playlist, and the resultant scheduling of that item during the presentation of the playlist on the video display unit 120 and speakers 140 of the POS system 100. The priority level for an audiovisual item can be set manually by a user, or it may be set automatically (and optionally be intermittently modified) by a system such as the automated marketing action system.

The display frequency field 308 maintains data representative of the number of times the associated audiovisual item is to be displayed during a particular time interval. For example, the field may include two values, with one of the values indicating the number of times the audiovisual item is to be presented, and the other value indicating the applicable time interval (e.g., a requirement that an audiovisual item be presented five times every 40 minutes can be represented as a pair of values of 5 times, and 40 min). Specification of the values representative of the frequency maybe provided using various types of time units (e.g., seconds, minutes, hours, etc.). Like the priority data in priority level field 306, the data in the display frequency field can also be manually set, and intermittently modified, by a user, or be set and/or modified automatically.

The duration length field 310 stores data representing the presentation time of the audiovisual item. For audiovisual items that include video and/or audio clips, the data held in the duration length field may comport with the actual running length of the content held (or pointed to) in content field 304. Under those circumstances the data held in the duration length field 310 may be determined automatically by computing the length of the audiovisual item from the content stored in content field 304. Alternatively, the data in the duration length field 310 may not comport with the actual length of the running time of the audiovisual content data in field 304. For example, the value in the duration length field may have been set (manually or automatically) to represent the maximum presentation time allotted for the associated audiovisual item. Under these circumstances, the value specified in the field 310 may be used to represent the cut-off point at which presentation of the associated audiovisual item will cease. Optionally, the data structure 300 may include additional fields related to the duration length field that may specify additional parameters about the manner in which the audiovisual item is to be presented. For example, another field can specify a starting point for the associated audiovisual item from which presentation of the audiovisual item will begin. Another field can represent a certain compression or contraction factor (or alternatively, an expansion factor) regulating the speed at which the data is presented, thus contracting or expanding the corresponding frequency spectrum for the content of the audiovisual data.

The data structure 300 further includes an exposure-level field 312 that maintains a value representative of the portion of time the associated audiovisual item is to be displayed during a particular time period. In some embodiments the exposure level data is represented as a fraction or as a percentage value that is indicative of the extent to which the associated audiovisual item should be exposed (i.e., presented) for any arbitrary time interval (the exposure level value is thus sometimes referred to as the “airtime fraction”). For example, a value of 0.3 or 30% indicates that the associated audiovisual item should be presented for 30% of the time of any given time interval that the playlist is being presented. In some embodiments, the exposure level data is computed based on the display frequency data in the field 308 and on the duration length data in field 310. In some embodiments, the exposure level value can be computed as the total presentation time during the corresponding interval specified in the display frequency field 308. Thus, for example, for frequency data indicating that the audiovisual item is to be displayed five (5) times in a 40 minute interval, and the duration length field 310 indicates that the associated audiovisual item has a length of 10 seconds, the corresponding exposure level value is computed as 10 seconds×5 times//(40 minutes*60 seconds)= 1/48=2.083%. Computation of the exposure level for the audiovisual items normalizes the data in the frequency field 308 and the duration length field 310 to thus enable subsequent scheduling operations, as will be described herein, to be based on a standard data representation (namely, the exposure level representation.) When the display frequency and/or duration length are modified during presentation of the one or more playlists on the video display unit 120 and speakers 140 of the POS system 100, the exposure level data in field 312 is similarly modified in accordance with the modified valued on which the exposure level data is based.

Other fields for storing additional data may be added to data structure 300. For example, data structure 300 may include fields pertaining to a product or service associated with the corresponding audiovisual item. Under those circumstances, the records formatted according to data structure 300 may include such fields that describe the product/service, its pricing, as well as user-entered information (e.g., from a consumer or some or retailer) interacting with the POS system 100. Alternatively, information about products/services associated with a particular audiovisual item may be formed and maintained separately from the records for the audiovisual item.

Records formatted according to data structure 300 may be stored and managed using application implementing procedures for storing and/or managing records, including, for example, commercial database applications such as DB2™ and Oracle™.

### Assignment of Audiovisual Items to Playlists

The records corresponding to the multiple audiovisual items (e.g., records formatted in accordance with, for example, data structure 300) stored in the storage module 114 of the POS system 100 are initially assigned to one or more playlist. This assignment may be controlled by an operator. For example, the operator may select the items for the playlist from the available records, and set their length (unless length is implicitly provided by the item's running time, e.g., a movie's running time), frequency and/or time period (e.g., “3 times each hour”) and priority. Selection of the audiovisual items assigned to a particular playlist may be performed at the POS system 100 through the input devices 130, or it may performed from a remote location. For each of the audiovisual items selected, the operator can either see the exposure level (i.e., airtime fraction) for that item, expressed as a percentage, or the exposure level as expressed in terms of time units out of a predefined time frame. For example, if an audiovisual item is 30 seconds long, the operator requested that it be displayed 5 times every 90 minutes, and the time frame is 1 hour, the exposure level would be 1 minute and 40 seconds, and the user will see “1:40”. The operator can view his selection on the video display unit 120 of the POS system 100 (if the operator is making his selection at the POS system 100), or be may view selection at a monitor device of a remote processing-based device.

The selected audiovisual items may be sorted by priority level, and the operator may view the item in terms the total airtime fraction for each priority level, as well as a cumulative usage of airtime fraction by that priority and all the lower priority levels. This information may also be displayed graphically.

Alternatively, assigning audiovisual items to a playlist may be performed automatically based, for example, on a scheme that assigns the multiple available audiovisual items to the one or more audiovisual items such that there is parity between the various playlists in terms of the number of audiovisual items assigned thereto, and/or in terms of the aggregate duration length of the audiovisual items in each of the playlists. Alternatively or additionally, assignment of the audiovisual items to the one or more playlists can also be performed to achieve parity in terms of the distribution of the types of audiovisual items in every playlist. For example, the assignment of audiovisual items (and/or their corresponding records) can be performed so that every playlist includes substantially the same number of video-based audiovisual items, and/or includes substantially the same number of audiovisual items having a particular priority level. In some embodiments only a single playlist is used, and thus in those circumstances all the audiovisual items available for presentation on the POS system 100 are assigned to that one playlist.

Having assigned the audiovisual items to the one or more playlists, the POS system 100 (or some other computing device interconnected to the POS system 100) next identifies the audiovisual items, for a particular playlist, that will be presented on the POS system 100. In other words, some of the audiovisual items assigned to a particular playlist are selected for presentation, while some of the assigned audiovisual items may not be included in the playlist for presentation. As will become apparent below, one constraint that is used in the selection process is that the sum of the exposure level data for those audiovisual items that are to be presented in the playlist cannot exceed 100% (i.e., you can only display audiovisual time in no more than the full 100% of the time that is available.)

In identifying the specific audiovisual items that are to be presented (i.e., audiovisual items that will receive “air time”) on the POS system 100, a scheme based on priority may be employed. In some embodiments identification of those audiovisual items to be included in the playlist for presentation may be based on traversing in order all the audiovisual items, starting with those audiovisual items having the highest priority, until the sum of the exposure level of the audiovisual items thus added reaches or exceed 100% of the available time. If the last audiovisual item(s) to have been added caused the running sum of exposure level data to exceed 100%, an exposure level data adjustment procedure is applied to the exposure level data of the audiovisual items identified, as will be more particularly described below, to adjust the respective exposure level data so that the sum of the adjusted exposure level data equals 100%.

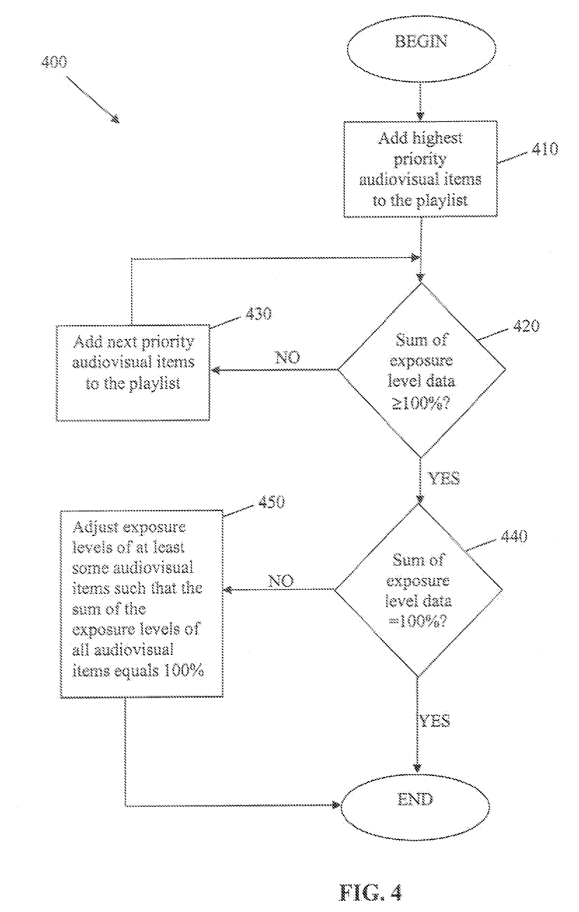

With reference to FIG. 4, showing a flowchart of an exemplary embodiment of a procedure 400 for identifying one or more audiovisual items to be included in a playlist for presentation, the audiovisual items corresponding to the highest priority level are added to the particular list at 410. At 420, the sum of the exposure level data corresponding to each of the audiovisual items thus added is totaled, and a determination is made of whether the sum exceeds or is equal to 100% exposure. If the sum exceeds 100%, as may be determined at 440, then the playlist includes audiovisual items whose total exposure level exceeds the total time that is available for presenting all the audiovisual items added to the playlist, and accordingly, no additional audiovisual items will be added to the playlist.

Moreover, because the aggregate exposure level of the audiovisual items exceeds the total available air-time it is necessary to adjust the exposure levels of at least some of the audiovisual items included at 410. Therefore, the exposure levels of at least some of the audiovisual items (e.g., the audiovisual items corresponding to the audiovisual items associated with the last priority level group to be added) are adjusted, at 450, such that the sum of the adjusted exposure level of those audiovisual items, and the exposure levels of the audiovisual items of all other audiovisual items (e.g., audiovisual items associated with priority groups having a higher priority) add-up to exactly 100%. In some embodiments, adjustment of the exposure levels of the audiovisual items is performed by first determining an adjustment factor with respect to which me multiplication of the audiovisual items to be adjusted with that adjustment factor will result in the sum of the exposure level of all the audiovisual items included in the playlist being 100%. In some embodiment, the exposure levels of audiovisual items in other priority groups may also be adjusted. For example, audiovisual items in different priority groups may be adjusted using different weighing adjustment factors for each of the various priority groups included in the playlist. In some embodiment, the exposure levels of individual audiovisual items in particular priority groups may be adjusted using different weighing adjustment factor. In the afore-mentioned embodiments, the sum of the exposure levels of all audiovisual items totals 100%.

With respect to the situation in which the exposure levels of the audiovisual items of the highest priority group exceed 100%, the exposure levels of audiovisual items of the highest priority group are adjusted using a weighing adjustment factor to cause the sum of the exposure levels of the audiovisual items to equal 100%.

If it is determined at 440 that the sum of all the currently added audiovisual items matches 100%, no adjustment of the exposure levels is necessary, and procedure 400 is completed.

If it is determined, at 420, that the sum of the exposure level of the audiovisual items that have been included with the playlist does not exceed 100%, then the audiovisual items of the next priority group are added to the playlist at 430. Subsequently, at 420, a determination is made again as to whether the sum of the exposure levels of all audiovisual items thus far included in the playlist exceeds or is equal to 100%. If the aggregate sum of the exposure levels of all the audiovisual items included in the playlist does not equal or exceed 100%, then the audiovisual items of the next priority level group are added to the playlist at 430.

This process of repeating 420 and 430 continues until a determination is made that the sum of the exposure levels of the audiovisual items matches or exceeds 100%. Once the sum of the exposure level matches or exceeds 100%, procedure 400 performs the exposure level adjustment process, at 450, as described above.

From time to time, as maybe desired, the operator overseeing the assignment and selection of audiovisual items may view which audiovisual items caused the utilized aggregate exposure level to go over the 100% mark. In some embodiments, the priority level that resulted in the utilized airtime to reach and/or exceed the 100% mark will be identified using a special mark. Additionally, the operator may also receive information indicating which audiovisual items had their exposure level adjusted, as well as information about the adjusted exposure levels for those items.

If the playlist goes intermittently off the air, the operator can either set and see information based on the playlist's relative terms (i.e., assuming the playlist is on all the time) or in actual terms (i.e./ taking into consideration the fact that the playlist is not on all the time). For example, if the playlist only displays 40% of the time, in the former alternative an item that is set displays 20% of the time will actually be presented 8% of the time (as it takes 20% of the playlist airtime), and in the latter alternative the item will display 20% of the time, and it will take 50% of the playlist airtime for that playlist.

### Greedy Scheduling Techniques

Having identified one or more audiovisual items that are included in the particular playlist, the identified audiovisual items are next arranged in a presentation schedule based on the exposure levels of the identified audiovisual items, and using one or more scheduling strategies that are applied to the identified audiovisual items. As described herein, some scheduling strategies that maybe used include “Greedy” strategies, optimization strategies, etc.

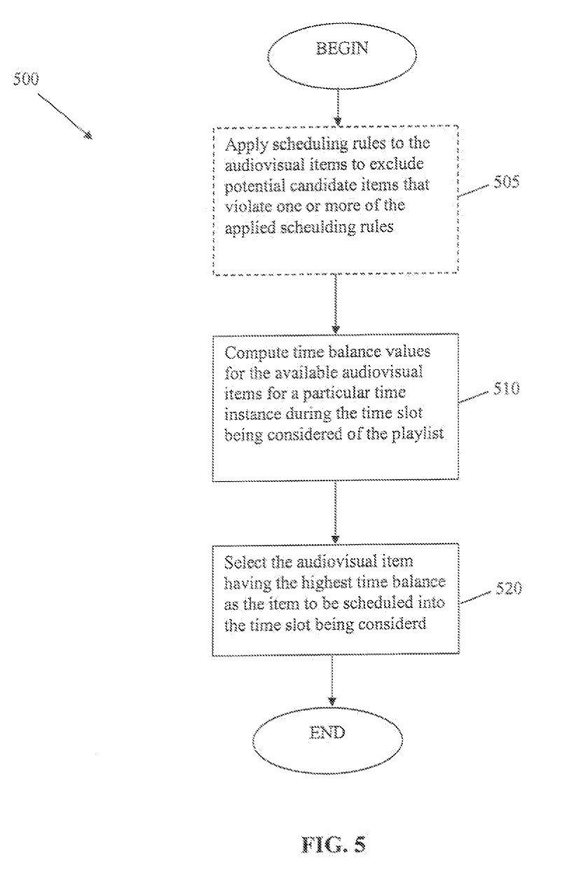

FIG. 5 is a flowchart of an exemplary embodiment of a procedure 500 that implements a greedy scheduling strategy. Greedy schemes are schemes that are used to determine solutions for multi-stage problems. At each stage the greedy scheme implemented determines a local optimum solution for the stage in question. The overall solution, therefore, includes a series of local optimum solutions. Although in some situations the sequence of local optimal solutions may also represent the global optimum solutions, greedy techniques do not specifically seek a global optimum solution.

Thus, application of a greedy scheduling strategy to the identified one or more audiovisual items included in the playlist seeks to determine the schedule of the audiovisual items on a slot-by-slot basis. For example, the greedy strategy seeks to determine the next audiovisual item to schedule after the currently presenting audiovisual items from the available audiovisual items of the playlist.

A useful concept to facilitate implementation of the greedy scheduling strategy and also the implementation of other strategies as described herein, is the concept of time balance. As noted above, the time balance represents the entitlement of a given audiovisual item to be presented on the POS system 100. The time balance value, in effect, keeps a tab of the extent to which a particular audiovisual item has already been presented and, or conversely, the extent to which that the particular audiovisual item has been deprived of air-time, and thus has not been presented. The time balance for a particular audiovisual item can have a positive or negative value. A positive value indicates that the audiovisual item has acquired presentation time entitlement (i.e., it is owed “air-time”.) A negative time balance value indicates that the particular audiovisual item has been presented on the POS system 100 more than it is entitled to (i.e., it has used-up more “air-time” than it was entitled to.)

In some embodiments the time balance value for a particular audiovisual item is computed as the difference between the product of the exposure level of the particular audiovisual item and the time that it has not been playing (as measured from some earlier time instance), and the total time that the playlist has been playing. That is:

TB_{T}=Exposure Level×{Total time)_{T}−(Playing Time)_{T} (1)

where TB is the time balance value at time T for the audiovisual item. Exposure Level is the corresponding exposure level for that audiovisual item, Total Time is the elapsed time at time instance T (generally, Total Time will be the same as T if both terms started from 0), and Playing Time is the time, at the time instance T, that the audiovisual item has been playing. Thus, under this formulation, an audiovisual item “earns” a time balance credit equal to its fraction of the air-time for every second that it is on the active playlist, and is charged a full second for every second that it is being presented on the POS system 100. By way of an example, suppose a particular audiovisual item, having an exposure level of 0.4 (or 40%), has played 2 minutes during a time interval of 10 minutes. Under these circumstances, the time balance at the 10 minute mark is computed as TB=0.4×10 minutes−2 minutes=2 minutes (or 120 seconds). Therefore, that audiovisual item has a positive balance of 2 minutes at the 10 minute mark.

Other formulations for an audiovisual item's time balance may be used.

It is to be noted, however, that because items of shorter length would generally use up less of their time balances to present (as provided by Formula (1), the “cost” for presenting is the duration length of the item being presented), then they should receive some precedence over longer items having the same time balance. Therefore, in some embodiments, the time balance values are normalizing by dividing the value computed by Formula (1) by the corresponding duration length data for that audiovisual item.

Other ways to compute a value representative of the entitlement of an audiovisual item to be presented may be used.

With reference to FIG. 5, at some point prior to the projected start of an audiovisual item at the next available time slot (e.g., prior to the completion of the currently playing audiovisual item), the time balance value at a particular time instance for each of the audiovisual items included in the particular playlist is computed at 510 using, for example. Formula (1) provided herein. In applying Formula (1), or some other formula, one of three different time evaluation points may be used. Particularly, for a given audiovisual item that is a candidate for scheduling after the currently playing audiovisual item, the time points that may used to compute the time balance value include the time balance once presentation of that audiovisual ends (the so-called “end time”), the time balance for that audiovisual item just prior to the beginning of its presentation (the “begin-time”), or the time balance for that audiovisual item at exactly the half-way point of that audiovisual item (the “half-way point”). It is to be noted that the time balance values being computed at 510 are the prospective time balance values that would result if the audiovisual item associated with a given computed time balance value is selected. As noted above, the resultant time balance values may be normalized by, for example, the duration lengths of the respective audiovisual items to reduce biasing effects that may favor the ultimate selection of shorter duration audiovisual items.

Optionally, prior to computing the time balance values for the various audiovisual items, procedure 500 may determine, at 505, whether any of the audiovisual items available to be scheduled into the time slot being considered violates one of several scheduling rules. Scheduling rules, which may be stored on the storage module of the POS system 100, or one some other remote device, may be used to exclude certain scheduling scenarios. For example, such rules may be used to preclude competing advertisement from being presented in sequence, or may preclude advertisements for certain products/services from being shown immediately after advertisement for another class of products/services. As another example, the scheduling rules may place constraints on how soon after being presented the same audiovisual item may be presented again. The set of rules that may be applied to candidate audiovisual items may be intermittently modified in response to fluctuating marketing conditions using, for example, a system for automatic control of marketing actions.

Once the prospective time balance values for the various audiovisual items have been computed, in some embodiments the audiovisual item having the highest time balance value (actual or normalized) at the particular time evaluation point is selected at 520 as the audiovisual item to be scheduled in time slot in question. Other schemes for selecting the audiovisual item to be scheduled for the time slot being considered may be used instead.

It is to be noted that scheduling of the audiovisual items into a particular future time slot may be done at any given time. Thus, in some embodiments, the scheduling, based on greedy schemes, for a single time slot that follows the time slot of the currently playing audiovisual item may be performed prior to the completion of the currently playing audiovisual item. Alternatively, in some embodiments, a complete schedule, for some specified time interval (e.g. 1 hour), that includes multiple scheduled audiovisual items, is generated. In circumstances where a complete schedule is generated, the greedy scheduling scheme used is applied individually with respect to each of time slots in the schedule that are to be considered.

### Optimization Scheduling Techniques

Unlike greedy scheduling techniques which determine the optimal scheduling of audiovisual items on a stage-by-stage basis (i.e., determine the first item in the schedule, then, in view of that selection, determine the second item in the schedule, and so forth), optimization scheduling strategies determine a complete optimal schedule. In other words, optimization scheduling techniques seek to identify a global optimum rather than a sequence of local optima.

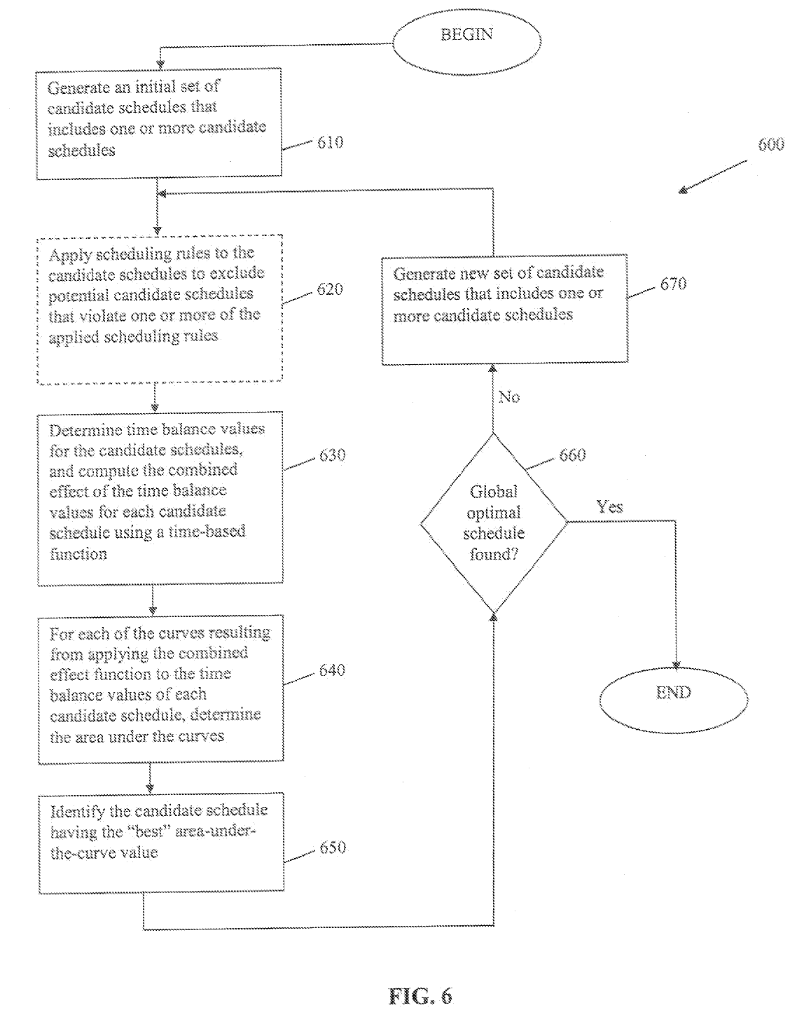

In some embodiments, the optimization scheduling strategies determine the optimal display order for the audiovisual items included in a particular playlist based on time balance values, which in turn are computed based on exposure level data for the audiovisual items included in the playlist. With reference to FIG. 6, showing a flowchart of art exemplary embodiment of a procedure 600 for determining an optimal display order for the audiovisual items, an initial set of candidate schedules is generated from the available audiovisual items for the playlist. In situations where the playlist includes a relatively small number of audiovisual items, there will be a relatively manageable number of possible permutations of candidate schedules to be evaluated, and thus it may be feasible to generate substantially all the various candidate schedules. However, in most situations, the number of possible schedule permutations may be too large to practically enable the generation of all possible schedule candidates. Moreover, subject only to scheduling rules that articulate constraints of how often a particular audiovisual item may be scheduled after it had previously played, it may be permissible for a candidate schedule, spanning some specified time interval, to include a particular audiovisual item multiple times within the schedule while not inserting another audiovisual item into the schedule at all during that time interval. Thus, under these circumstances, generation of all possible candidate schedules at 610 may be impractical.

Accordingly, the initial set of candidate schedules may be generated by decomposing the problem into more compact, and thus more manageable sub-problems, and generating separate sets of candidate schedules for each of the sub-problems. For example, the problem of scheduling the audiovisual items over an interval of 60 minutes could be decomposed into scheduling the audiovisual items over four (4) time intervals of fifteen (15) minutes. Decomposing of a larger scheduling problem into several compact scheduling problems yields solutions for the more compact problems that together constitute a reasonably optimal solution for the larger scheduling problem.

Alternatively and/or additionally, an initial set of candidate schedule may be formed based on some criteria to guide the generation of the initial schedules (e.g., schedule all audiovisual items at least once, subject to any existing scheduling rules, with high priority audiovisual items being scheduled first.)

Optionally, at 620, scheduling rules that specify various scheduling constraints are applied to the candidate ordered sequences of audiovisual items generated at 610 to determine if those schedules violate any of the scheduling rules. Similar to the scheduling rules applied in relation to possible schedules generated using greedy scheduling techniques, the scheduling rules applied in 620 may be used to exclude certain scheduling scenarios. For example, such rules may be used to preclude competing advertisement from being presented within certain time slot intervals from each other. The set of rules for the optimization technique may be intermittently modified in response to fluctuating marketing conditions. On the other hand scheduling rules used in relation to the optimization scheduling techniques are applied to candidate sequence as a whole, and not individually to particular audiovisual items, to rule out candidate schedules in their entirety.

Having identified at least one valid initial candidate schedule, in some embodiments the optimal display order (i.e., the optimal schedule) is determined by iteratively generating candidate schedules until the final resultant schedule is obtained that, for example, minimizes the area under the curve of some time-based function that represents the behavior of the combined time balance contributions of the audiovisual items of the resultant schedule.

Specifically, one of several functions to represent the combined time balance behavior for a particular schedule may be used. Because the temporal behavior of the time balances associated with individual audiovisual items is such that they vary between positive values and negative values, and because the aggregate of the time balance of all audiovisual items of any schedule is 0, to formulate a meaningful function that is representative of the combined time-balance behavior for a particular schedule and which can be optimized, in some embodiments functions that include only positive terms are used. However, in some embodiments, functions that include negative terms, and/or include non-temporal terms, may be used.

One such time-based function that may be used is the sum of the squares of the time balance values of the audiovisual items of a particular schedule, which may be represented as;

$$f ( t ) = {\sum }_{f = 1}^{x} {[ {TB}_{i} ( t ) ]}^{2} = {{TB}_{1} ( t )}^{2} + {{TB}_{2} ( t )}^{2} + … + {{TB}_{n} ( t )}^{2} \qquad ( 2 )$$

where TB₁(t), TB₂(t), . . . , TBₐ(t) are the individual time-balance values, as a function of time, of the respective audiovisual items of a particular prospective schedule, and ƒ(t) is the time-based function of the sum of the squares of the time balance values of the audiovisual items. It is to be noted that every different schedule (e.g., different order in which the audiovisual items are presented) may result in a different time-based behavior of the sum of the square of the function shown in Equation (2).

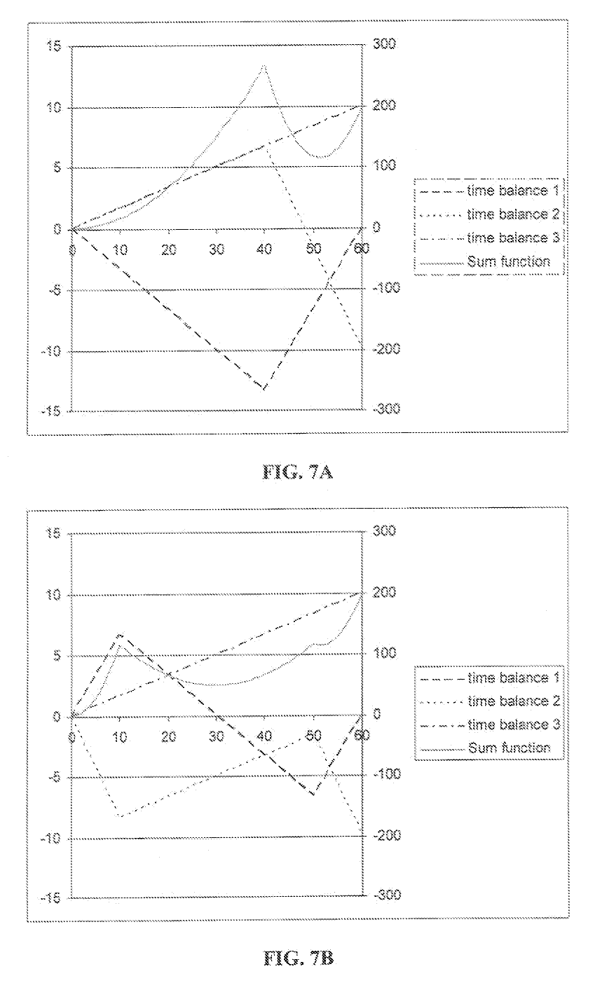

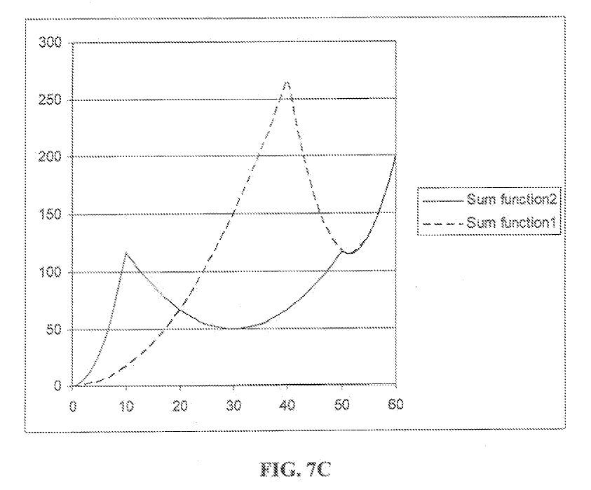

To illustrate the use of time-based functions representing the combined behavior of time balance contributions of audiovisual items to optimize schedule, reference is made to FIGS. 7A and 78. FIG. 7A is a graph showing a time-balance behavior example resulting when three audiovisual items are scheduled for presentation in a 60 second interval. In the example illustrated in FIG. 7A, the first audiovisual item (marked in the graph as “time balance 1”), which has a duration length of 40 second and an exposure level of 0.667, is scheduled to be played first, followed by two consecutive presentations of the second audiovisual item (marked in the graph as “time balanced 2”), winch has a duration length of 10 second and an exposure level of 0.167. The third available audiovisual item (marked in the graph as “time balance 3”), which has a duration length of 5 seconds and an exposure level of 0.166, is not scheduled to be presented at all during the 60 second presentation interval of this particular example.

As shown in FIG. 7A, when the first audiovisual item begins to play, its time balance immediately becomes negative because it is using more air-time than it currently has credit for in its time balance. The rate of decrease for the first audiovisual item corresponds to the product of the exposure level for the first audiovisual item and the overall time that has passed, less the actual playing rime of the audiovisual item. Thus, after 12 seconds nave passed, the time balance of the first audiovisual item is (0.667*12−12=−8 seconds). At the same time that the time balance of the first audiovisual item decreases, the time balance of the second and third audiovisual items increases at rates corresponding to the products of their respective exposure levels and the time that has passed (while the first item is playing, the second and third items are not playing, and therefore their time balances accrue credits.)

Once the first audiovisual item has finished play, the second audiovisual item begins its first of two consecutive presentations. During that time, the time balance of the second audiovisual item begins to decrease, while the time balance of the first audiovisual item begins to increase as its accruing credit without having to spend any of its time balance (because it is not being presented any longer.) The time balance of the third audiovisual item continues to increase during that time.

FIG. 7A also shows the behavior of the time-based function ƒ(t) as described in Equation (2) above (namely, the sum of the squares of the individual time balance contributions from the various audiovisual items.) As can be seen, the value of the sum of the squares function increases in value until it reaches a peak at 40 seconds (corresponding to when the first audiovisual item finishes its presentation).

FIG. 7B is a graph showing the time balance behavior for the same audiovisual items of FIG. 7A, but with respect to a different proposed schedule. Particularly, in the example illustrated in FIG. 7B, audiovisual item 2 is presented first, followed by audiovisual item 1, and then audiovisual item 2 again. As can be seen from FIG. 7B, with this particular schedule, the time balance behavior of the audiovisual items and the sum of the squares function changes. Particularly, because audiovisual item 1 begins presentation only after audiovisual item 2 has presented, by the time audiovisual item 1 begins presenting it has accrued some positive balance in its time balance. Accordingly, the time balance of audiovisual item 1 by the time it finishes playing (at t=50 seconds) is only −6.667 seconds, as opposed to −13.333 that it had when it finished playing its 40 second segment in the first example illustrated in FIG. 7A.

FIG. 7B also shows that the behavior of the sum of the squares function also changes when compared to the behavior of the function in FIG. 7A. Particularly, and with reference to FIG. 7C showing a comparison of the two curves of the sum of the squares functions of the examples of FIGS. 7A and 7B, the area under the curve corresponding to the sum of the squares in the second example is equal to 4,666.67 (measured in units of second³), and is smaller than the area under the curve corresponding to the sum of the squares in the first example, which is 6,666.67 sec³.

Thus, a change in the schedule of the items to be presented resulted in different time balance behaviors. As can also be seen from FIG. 7C, because a high value of the sum of the squares function may indicate that a particular audiovisual item is being overplayed (which may result in a large negative time balance), or that another audiovisual item is not being played enough (which may result in a large positive time balance value), under these circumstances the schedule used in the second example of FIG. 7B is more optimal than the schedule used in the first example of FIG. 7A.

Therefore, by trying to minimize the area under the curve of the combined time balance function, an optimal schedule maybe achieved. In addition to the sum of squares function used in the illustrations of FIGS. 7A-7C, other functions may be used to represent the time-dependent behavior of the combined effect of the time balances of the audiovisual items to be scheduled. These include:
sum of the absolute values of the time balances of the various audiovisual items;
weighted average of the sum of squares of the time balances of the items, weighted by the audiovisual items' associated exposure levels;
weighted average of the sum of absolute values of the time balance of the audiovisual items, weighted by the audiovisual items' exposure levels;
the standard deviations of the audiovisual items (i.e., from the average time balance value during the particular time interval); and
the weighted standard deviations, weighted by the audiovisual items' exposure levels.

Other functions representative of the time-balance behavior of the audiovisual items to be scheduled, including functions that perform operations other than aggregation operations, may be used. Further, determination of the optimal schedule to be used can be performed through procedures other than minimization procedures.

Thus, having selected the particular function representing the combined behavior of the time balance of the individual audiovisual items, the time balance values produced for the candidate schedules generated at 610 are determined in 630, and the values of the selected combined behavior function is determined for the interval corresponding to the candidate schedules. Subsequently, the area under the curve for the determined values resulting from applying the combined behavior function to the candidate schedules are computed, at 640, using one or more of several integration or summation procedures. In some embodiments, the area under the curve may be computed using analytic integration procedures by calculating separately the actual symbolic, analytic representation of the individual terms of time-based function, and determining the integrals of the individual terms using symbolic analytic methods. This integration methodology is mostly applicable in situations involving simple functions, e.g., the sum of squares, where the function includes individual parabolas (i.e., 2^{nd} degree polynomials), and thus their respective integrals are readily solvable (i.e., 3^{rd} degree polynomials). In some embodiments, the area under the curve may be computed using numerical approximation procedures. For example, the time-based function is divided to finite elements, and the area underneath each of those divided areas is approximated to be a trapezoid, and is accordingly computed. Subsequently, the error associated with this approximation is estimated by bounding the trapezoid with a rectangle, and computing the bounded area (i.e., the difference between the area of the rectangle and the area of trapezoid). If the resultant error is deemed to be too high, the area under the time-based function is re-divide into smaller elements, and the above approximation procedure repeated.

Using the computed areas under the curve for the current candidate schedules, the candidate schedule having the best value (e.g., minimum value) from amongst the candidate schedules that were processed is identified at 650. Procedure 600 then determines, at 660, if the globally optimal schedule has been found.

For example, in some embodiments, the value of the area under the curve of the best candidate schedule identified at 640 is compared to the value of the area of the curve of previously evaluated candidate schedules (e.g., the “best” candidate schedule from a previous iteration). Under circumstances where the area under the curve value for the identified “best” candidate schedule is more optimal than the previously identified “best” value (e.g., the area under the curve for the current “best” candidate schedule is smaller than the area under the curve value for a previously identified “best” schedule), it follows that the optimal schedule has not been found yet. Procedure 600, therefore, continues to search for the optimal schedule. Thus, at 670, a new set of candidate schedules is generated from the “best” candidate schedule identified at 650.

There are several ways by which new candidate schedules can be generated. For example, in some embodiments, the identified “best” candidate schedule is incrementally modified so that a new candidate schedule is generated by changing a single aspect of the schedule. For example, the order of two audiovisual items in the identified “best” candidate schedule can be swapped. Alternatively, one particular audiovisual item from the “best” candidate schedule can be replaced with either an audiovisual item that was not in the “best” schedule (but which nevertheless was included in the corresponding playlist, or with an audiovisual item that already appears in the schedule. In this manner, a candidate set with at least one new candidate list, but possibly with a large number of new candidate schedules, is formed.

In some embodiments, generation of new candidate schedules can be achieved using Genetic Algorithm (GA) techniques. Typically, in GA techniques an initial population of candidate solutions (in this case, a subset of the candidate schedules evaluated at 630) is interbred using two basic operations: crossover (recombination), and mutation. In a crossover operation, the elements of the interbred solution (e.g., order of certain audiovisual items in a candidate schedule) are swapped. The occurrence of the crossover operation for two solutions may be predicated on some probabilistic event. Typically, genetic algorithm approaches use a crossover probability of between 0.6 and 1. Accordingly, candidate schedules may be interbred only if the some event (e.g., a random event generator may be used to facilitate this operation) has first occurred.

In a mutation operation, a resultant combined schedule (i.e., the offspring of interbred candidate schedules) is mutated by replacing one or more of its elements (e.g., the locations in the schedule of two or more audiovisual items) with other elements. Here too, the mutation operation may be predicated on some probabilistic occurrence. Typical mutation probabilities may be on the order of 0.01 or less.

Other ways to generate additional candidate schedules to be evaluated in the process of identifying an optimal schedule may be used.

Having generated the new candidate schedules, the scheduling rules are applied to these new candidate schedules to exclude any candidate schedule that violate any of the rules. The areas under the curves of the time-based functions representing the combined effect of time balance values for the various surviving candidates are computed at 640, and once again a “best” candidate schedule from this iterative batch of candidate schedules is identified at 650, and a determination is made at 660 if the identified “best” candidate schedule is more optimal than a candidate schedule identified in a previous iteration.

This iterative process continues until eventually a global optimal schedule is identified, the current solution is deemed good enough, or the time for starting to play the next item arrives, and thus the time period dedicated to finding a solution has reached its end. Alternatively, to avoid an overly long search for an optimal schedule, the procedure 600 may terminate once a pre-determined area-under-the curve value has been reached (i.e., once a candidate schedule has been identified whose area under the curve is less than some pre-determined low threshold.) Additionally, to avoid situations where a local optimum position is identified (e.g., a local minimum), a requirement may be imposed that the area under a curve corresponding to some potentially optimal schedule has to be below some pre-determined threshold, based on comparison to some estimating function that reflects typical optimal values. If a candidate schedule is determined to be an optimal schedule with respect to neighboring schedules, but the corresponding area under the curve of the time-based function computed for the schedule is too high, procedure 600 will continue searching for a different candidate schedules by using, for example, other schedules to generate new candidate schedules.

In some embodiments, determination of the optimal schedule may be achieved by decomposing the problem into more compact, and thus more manageable sub-problems, and generating separate sets of candidate schedules for each of the sub-problems. For example, and as explained above, the problem of scheduling the audiovisual items over an interval of 60 minutes could be decomposed into scheduling the audiovisual items over four (4) time intervals of fifteen (15) minutes. Subsequently, an optimal schedule for each of the divided interval is determined, possibly by brute identification of all, or a substantial portion of the possible schedule permutations for the intervals. The resultant global schedule then corresponds to the consolidation of the individual identified optimal schedules for the shorter intervals. Although the consolidated global schedule may not necessarily be the actual optimal schedule for the longer time interval. The consolidated global schedule is nevertheless deemed to be reasonably optimal.

In some embodiments, determination of the optimal schedule may be achieved by generating several candidate schedules using the greedy scheduling techniques, as described above. Although schedules generated using greedy techniques are not necessarily globally optimal in many circumstances the “greedy” schedules are nevertheless close in form to the schedule that would be globally optimal (in other words, greedy schedule are, in some situations, nearly-optimal.) Therefore, using greedy scheduling techniques may result in candidate schedules that are close to the globally optimal schedule, and thus subsequent searches for the optimal schedule could be shortened if the search proceeds from those initially generated “greedy” schedules.

Thus, to generate an initial set of “greedy schedules”, in some circumstances, candidate schedules may be generated by scheduling different audiovisual items as the first item in the candidate schedules, and determining the schedules that result from these different first-item scheduling. Alternatively, schedules determined using different time evaluation points may be generated (e.g./ generating one schedule by computing time balance values for audiovisual items at the “begin-time” of every time slot and generating another schedule by computing the time balance values at the “end-time” of the available slots). Thereupon, with the candidate “greedy” schedules having been generated, the global optimal schedule maybe sought by making incremental revisions to the initial “greedy” schedules to achieve a better, more optimal, schedule.

Other procedures for determining a global optimal schedule may be used.

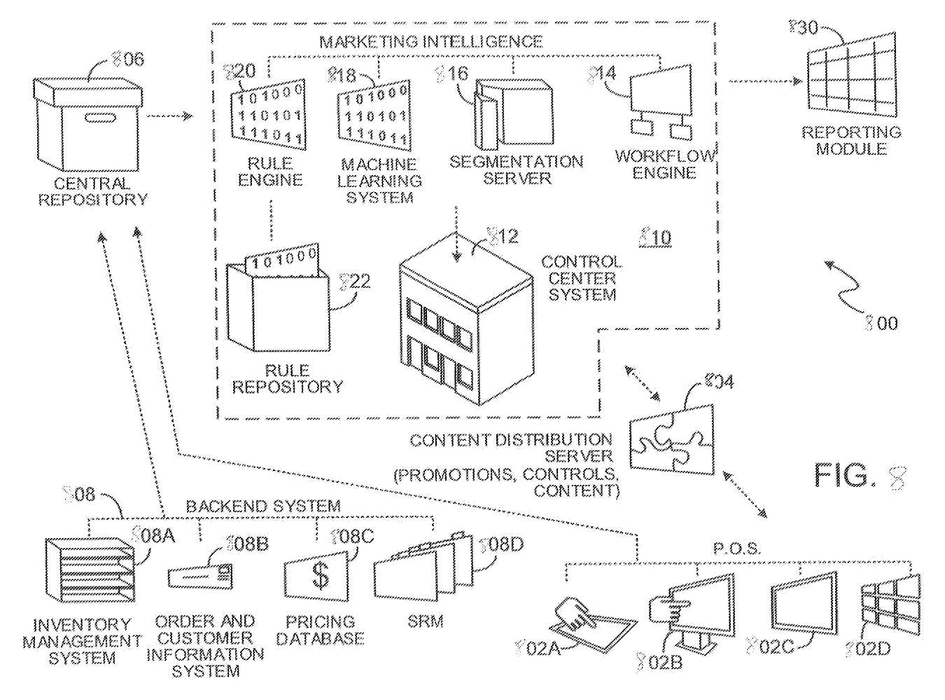

In some embodiments, the POS system 100 is interconnected to a system that initiates marketing actions based on various market conditions as determined, for example, from consumer trends, a retailer's inventory information, and other factors (e.g., external marketing conditions). Such a system can thus control the presentation of playlist on the POS system 100 by, for example, modifying attributes associated with particular audiovisual items, removing or including certain audiovisual items in playlists active on the POS system 100, etc, FIG. 8 is a schematic diagram of an exemplary embodiment of a system 800 for automatically controlling marketing actions based on marketing conditions, such as fluctuating consumers' behavior. Details regarding such a system are provided, for example. In U.S. patent application Ser. No. 11/314,713.

Briefly, as shown in FIG. 8, the system 800 includes one or more Point-of-Sale (“POS”) devices 802a-d. Each of the POS system 802a-d is similar to the POS system 100 described above, and is configured to operate in a manner similar to the operation of the POS system 100. Particularly, the POS systems 802a-d are electronic service display devices configured to present playlists that include one or more audiovisual items, and/or other information, to consumers and/or other users (e.g., store personnel). The POS systems 802a-d are also configured to collect information regarding the consumers' interests and actions with respect to the products/services presented on the POS systems 802a-d. In some embodiments the POS systems 802a-d receive the content that they present to consumers from a content distribution server 804. In other embodiments, the content is stored at some earlier point directly on the POS systems 802a-d, and the content can be updated by downloading new content from portable storage media (e.g., CD's).

Information collected by the POS systems 802a-d is sent to a central repository 806, where information from various POS systems, corresponding to one or more entities (e.g., different retail chains) are stored. The central repository 806 also receives information from the backend systems of the various entities operating the POS systems. Backend information systems 808a-d (operated by a particular entity) supplements the information collected by the POS systems with additional business data, such as the entity's inventory levels at its various outlets, sales transactions, pricing information for the entity's various products and/or services, etc.

The data collected by the central repository 806 is then processed by a marketing intelligence system 810. The marketing intelligence system includes a workflow engine 814 which controls the operations executing on the various modules of the marketing intelligence system 810. The marketing intelligence system 810 includes a segmentation server 816 which retrieves records from the central repository 806 and places those records into segmented groups. The marketing intelligence system 810 also includes the rule engine 820 which applies rules, specifying marketing actions, based on a determination by a machine learning system 818 of whether the projected effectiveness that would result from the execution of those marketing actions would exceed a performance threshold. If the projected effectiveness matches or exceeds such a pre-defined threshold, the marketing actions defined in the rules are implemented on the various systems of system 800 affected by the marketing actions (e.g., one or more POS system, one or more of the backend systems, etc.) The marketing actions thus adjust the marketing attributes of the affected products and services information produced by the marketing intelligence system 810 is also sent to the reporting module 830. User control of the marketing intelligence system 810 is achieved using the control center system 812.

Each of the various systems and devices shown in FIG. 8 is a processor-based device that includes a computer and/or other types of processor-based devices suitable for multiple applications. Such devices can include volatile and non-volatile memory elements, and peripheral devices to enable input/output functionality. Such peripheral devices include, for example, a CD-ROM drive and/or floppy drive, or a network connection, for downloading related content to the connected system. Such peripheral devices may also be used for downloading software containing computer instructions to enable general operation of the respective system/device, and for downloading software implemented programs to perform operations in the manner that will be described in more detailed below with respect to the various systems and devices shown in FIG. 8.

Further, the various systems and devices comprising system 800 are connected using conventional network arrangements. For example, the various systems and devices of system 800 may constitute part of a private packet-based network. Other types of network communication protocols may also be used to communicate between the various systems and devices. Alternatively, the systems and devices may each be connected to network gateways that enable communication via a public network such as the internet. Each of the systems and devices of system 800 may, under those circumstances, include security features, such as a firewall, VPN and/or authentication applications, to ensure secured communication. Network communication links between the systems and devices of system 800 may be implemented using wireless or wire-based links. Further, dedicated physical communication links, such as communication trunks may be used. Some of the various systems described herein may be housed on a single processor-based device (e.g., a server) configured to simultaneously execute several applications.

System 800 can thus be used to control the POS systems 802a-d. Particularly, in response to input received by the marketing intelligence system 810 that is indicative of some variation in existing marketing conditions, the system 810 may determine that additional marketing promotion may be required in relation to one or more products/services. A marketing action affected by the marketing intelligence system may cause one or more of the attributes specified in records, formatted according to the data structure 300, of audiovisual items corresponding to the products/services in question to be adjusted. For example, the display frequency data specified in held 308 of the corresponding records could be adjusted to specify a higher display frequency. Consequently, the exposure levels associated with the records will change, thus potentially necessitating a change to a schedule of a playlist that includes the audiovisual items at issue. Accordingly, a new schedule that reflects the adjustment to the records of the audiovisual items may be determined using, for example, procedure 500 (implementing a particular greedy scheduling technique) and/or procedure 600 (implementing a particular optimization scheduling technique).

### Other Embodiments

A number of embodiments of the invention have been described. Nevertheless, it will be understood that various modifications may be made without departing from the spirit and scope of the invention. Accordingly, other embodiments are within the scope of the following claims.

What is claimed is:

1. A method for determining a schedule for presenting audiovisual items, the method comprising;
providing a plurality of audiovisual items, each of the plurality of audiovisual items associated with a corresponding priority data;
assigning to each of the plurality of audiovisual items a corresponding exposure level data representative of the portion of time the corresponding audiovisual item is to be presented during a particular time interval;
identifying one or more audiovisual items from the plurality of audiovisual items that are to be included in a playlist of audiovisual items based, at least in part, on the corresponding priority data of the plurality of audiovisual items; and
determining a presentation schedule fox the identified one or more audiovisual items based, at least in part, on the corresponding exposure level data.

2. The method of claim 1, wherein each of the plurality of audiovisual items is further associated with a corresponding presentation frequency data representative of the number of times to present the corresponding audiovisual item, and a corresponding duration length data for the corresponding audiovisual item, and wherein assigning to each of the plurality of audiovisual items the corresponding exposure level data comprises determining the corresponding exposure level data based on the corresponding presentation frequency data and the corresponding duration length data.

3. The method of claim 1, wherein identifying one or more audiovisual items comprises adjusting the exposure level data of at least some of the identified one or more audiovisual items based on the sum of the respective exposure level data of the one or more audiovisual items.

4. The method of claim 3, wherein adjusting the exposure level data comprises:
based on the sum of the respective exposure level data of the identified one or more audiovisual items exceeding a value corresponding to 100%, identifying at least one group of audiovisual items having the same priority level data; and
adjusting the exposure level data associated with the audiovisual items in the identified at least one group such that the sum of the respective exposure level data of the identified one or more audiovisual items is equal to a value corresponding to 100%.

5. The method of claim 4, wherein adjusting the exposure level data associated with the audiovisual items in the identified at least one group comprises multiplying the exposure level data associated with each of the audiovisual items in the at least one group with a corresponding weighing factor.

6. The method of claim 1, wherein determining the presentation schedule comprises:
computing for each of the identified one or more audiovisual items included in the playlist using the exposure level data, a corresponding time balance value at a corresponding particular time instance, the corresponding time balance value representative of the presentation time the corresponding audiovisual item is entitled to at the corresponding particular time instance; and
selecting one audiovisual item from the identified one or more audiovisual items based on the computed time balance value for each of the identified one or more audiovisual items.

7. The method of claim 6, wherein computing for each of the identified one or more audiovisual items the corresponding time balance value comprises:
computing the difference between the product of the exposure level data for the corresponding audiovisual item and the total time elapsed at the corresponding particular time instance, and the time the corresponding audiovisual item has already presented at the particular time instance.

8. The method of claim 7, wherein computing the corresponding time balance value further comprises:
dividing the computed difference by a duration length data associated with the corresponding audiovisual item.

9. The method of claim 6, wherein for each of the identified one or more audiovisual items, the corresponding particular time instance includes one of: a begin time instance at which the corresponding audiovisual item would begin presenting, an end time instance at which the corresponding audiovisual item would end presenting, and a half-way point of the corresponding audiovisual item.

10. The method of claim 6, wherein the selected one audiovisual item has the highest time balance value.

11. The method of claim 6, wherein selecting one audiovisual item from the identified one or more audiovisual items includes applying scheduling rules.

12. The method of claim 11, wherein applying scheduling rules comprises determining whether a selected candidate audiovisual item violates any of the scheduling rules.

13. The method of claim 1, wherein determining the presentation schedule comprises;
determining an optimal presentation order for the identified one or more audiovisual items based on corresponding time balance values computed for each of the ordered one or more audiovisual items using the exposure level data, the time balance values representative of the presentation time the corresponding audiovisual items are entitled to at a particular time instance.

14. The method of claim 13, wherein determining the optimal presentation order comprises:
computing the difference between the product of the exposure level data for the corresponding audiovisual item and the total time elapsed at the particular time instance, and the time the corresponding audiovisual item has already presented at the particular time instance.

15. The method of claim 14, wherein computing the corresponding time balance value further comprises;
dividing foe computed difference by a duration length data associated with the corresponding audiovisual item.

16. The method of claim 13, wherein determining the optimal presentation order comprises minimizing the area under a curve of a time-based function of at least one of; a sum of squares of the time balance values for the corresponding identified one or more audiovisual items, a weighted average of the sum of the squares of the time balance values corresponding to the identified one or more audiovisual items, a sum of the absolute values of the time balances of the corresponding one or more identified items, a weighted average based on the exposure level data of the sum of absolute value of the time balance corresponding to the identified one or more audiovisual items, a standard deviation of the identified one or more audiovisual items, and a weighted average based on the exposure level data of the standard deviation of the identified one or more audiovisual items.

17. The method of claim 16, wherein the area under the curve is computed using at least one of: an analytic integration procedure, and a numerical approximation procedure.

18. The method of claim 13, wherein determining the optimal presentation order for the identified one or more audiovisual items comprises:
generating a plurality of candidate presentation orders for the identified one or more audiovisual items; and
applying scheduling rules to the plurality of candidate presentation orders.

19. The method of claim 18, wherein applying scheduling rules to the plurality of candidate display orders comprises determining whether any of the plurality of candidate presentation orders violates any of the scheduling rules.

20. The method of claim 2, further comprising changing for at least one of the plurality of audiovisual items, at a specified time, at least one of: the corresponding priority data, the corresponding presentation frequency data, and the corresponding duration length data.

21. The method of claim 20, wherein changing comprises:
modifying at least one of the corresponding priority data, the corresponding presentation frequency data, and the corresponding duration length data based on information sent from a marketing intelligence automated system, the information representative of automatically generated marketing actions.

22. The method of claim 1, wherein providing a plurality of audiovisual items comprises:
receiving data from a user, the data including at least one of data identifying the plurality of audiovisual items, priority data associated with one or more of the plurality of audiovisual items, presentation frequency data associated with another one or more of the plurality of the audiovisual items, and duration length data for a further one or more of the plurality of the audiovisual items.

23. A computer program product residing on a computer readable storage medium for determining a schedule for presenting audiovisual items comprising instructions that when executed on a processor-based device cause the processor-based device to;
provide a plurality of audiovisual items, each of the plurality of audiovisual items associated with a corresponding priority data;
assign to each of the plurality of audiovisual items a corresponding exposure level data representative of the portion of time the corresponding audiovisual item is to be presented during a particular time interval;
identify one or more audiovisual items from the plurality of audiovisual items that are to be included in a playlist of audiovisual items based, at least in part, on the corresponding priority data of the plurality of audiovisual items; and
determine a presentation schedule for the identified one or more audiovisual items based, at least in part, on the corresponding exposure level data.

24. The computer program product of claim 23, wherein each of the plurality of audiovisual items is further associated with a corresponding presentation frequency data representative of the number of times to present the corresponding audiovisual item, and a corresponding duration length data for the corresponding audiovisual item, and wherein the instructions that cause the processor-based device to assign to each of the plurality of audiovisual items the corresponding exposure level data comprise instructions that when executed cause the processor-based device to determine the corresponding exposure level data based on the corresponding presentation frequency data and the corresponding duration length data.

25. The computer program product of claim 23, wherein the instructions that cause the processor-based device to determine the presentation schedule comprise instructions that when executed cause the processor-based device to;
compute for each of the identified one or more audiovisual items included in the playlist, using the exposure level data, a corresponding time balance value at a corresponding particular time instance, the corresponding time balance value representative of the presentation time the corresponding audiovisual item is entitled to at the corresponding particular time instance; and
select one audiovisual item from the identified one or more audiovisual items based on the computed time balance value for each of the identified one or more audiovisual items.

26. The computer program product of claim 23, wherein the instructions that cause the processor-based device to determine the presentation schedule comprise instructions that when executed cause the processor-based device to:
determine an optimal presentation order for the identified one or more audiovisual items based on corresponding time balance values computed for each of the ordered one or more audiovisual items using the exposure level data, the time balance values representative of the presentation time the corresponding audiovisual items are entitled to at a particular time instance.

27. The computer program product of claim 26, wherein the instructions that cause the processor-based device to determine the optimal presentation order comprise instructions that when executed cause the processor-based device to minimize the area under a curve of a time-based function of at least one of: a sum of squares of the time balance values for the corresponding identified one or more audiovisual items, a weighted average of the sum of the squares of the time balance values corresponding to the identified one or more audiovisual items, a sum of the absolute values of the time balances of the corresponding one or more identified items, a weighted average based on the exposure level data of the sum of absolute value of the time balance corresponding to the identified one or more audiovisual items, a standard deviation of the identified one or more audiovisual items, and a weighted average based on the exposure level data of the standard deviation of the identified one or more audiovisual items.

28. The computer program product of claim. 24, further comprising instructions that when executed cause the processor-based device to change for at least one of the plurality of audiovisual items, at a specified time, at least one of: the corresponding priority data, the corresponding presentation frequency data, and the corresponding duration length data.

29. The computer program product of claim 28, wherein the instructions that cause the processor-based device to change comprise instructions that when executed cause the processor-based device to:
modify at least one of the corresponding priority data, the corresponding presentation frequency data, and the corresponding duration length data based on information sent from a marketing intelligence automated system, the information representative of automatically generated marketing actions.

30. A system comprising:
a display device configured to present one or more playlists of audiovisual items; and
a processor electrically connected to a memory module, the memory module storing instructions that when executed on the processor cause the processor to, for each of at least some of the one or more playlists:
provide a plurality of audiovisual items, each of the plurality of audiovisual items associated with a corresponding priority data;
assign to each of the plurality of audiovisual items a corresponding exposure level data representative of the portion of time the corresponding audiovisual item is to be presented during a particular time interval;
identify one or more audiovisual items from the plurality of audiovisual items that are to be included in the corresponding playlist of audiovisual items based, at least in part, on the priority data corresponding to the plurality of audiovisual items; and
determine a presentation schedule for the identified one or more audiovisual items based, at least in part, on the corresponding exposure level data.

31. The system of claim 30, wherein each of the plurality of audiovisual items is further associated with a corresponding presentation frequency data representative of the number of times to present the corresponding audiovisual item, and a corresponding duration length data for the corresponding audiovisual item, and wherein the instructions that cause the processor to assign to each of the plurality of audiovisual items the corresponding exposure level date comprise instructions that when executed cause the processor to determine the corresponding exposure level data based on the corresponding presentation frequency data and the corresponding duration length data.

32. The system of claim 30, wherein the instructions that cause the processor to determine the presentation schedule comprise instructions that when executed cause the processor to:
compute for each of the identified one or more audiovisual items included in the playlist, using the exposure level data, a corresponding time balance value at a corresponding particular time instance, the corresponding time balance value representative of the presentation time the corresponding audiovisual item is entitled to at the corresponding particular time instance; and
select one audiovisual item from the identified one or more audiovisual items based on the computed time balance value for each of the identified one or more audiovisual items.

33. The system of claim 30, wherein the instructions that cause the processor to determine the presentation schedule comprise instructions that when executed cause the processor to:
determine an optimal presentation order for the identified one or more audiovisual items based on corresponding time balance value's computed for each of the ordered one or more audiovisual items using the exposure level data, the time balance values representative of the presentation time the corresponding audiovisual items are entitled to at a particular time instance.

34. The system of claim 33, wherein the instructions that cause the processor to determine the optimal presentation order comprise instructions that when executed cause the processor to minimize the area under a curve of a time-based function of at least one of: a sum of squares of the time balance values for the corresponding identified one or more audiovisual items, a weighted average of the sum of the squares of the time balance values corresponding to the identified one or more audiovisual items, a sum of the absolute values of the time balances of the corresponding one or more identified items, a weighted average based on the exposure level data of the sum of absolute value of the time balance corresponding to the identified one or more audiovisual items, a standard deviation of the identified one or more audiovisual items, and a weighted average based on the exposure level data of the standard deviation of the identified one or more audiovisual items.

35. The system claim 31, further comprising instructions that when executed cause the processor to change for at least one of the plurality of audiovisual items, at a specified time, at least one of: the corresponding priority data, the corresponding presentation frequency data, and the corresponding duration length data.

36. The system of claim 35, wherein the instructions that cause the processor to change comprise instructions that when executed cause the processor to:
modify at least one of the corresponding priority data, the corresponding presentation frequency data, and the corresponding duration length data based on information sent from a marketing intelligence automated system, the information representative of automatically generated marketing actions.
